(19) United States
(12) Patent Application Publication
(10) Pub. No.: US 2006/0106627 A1
(43) Pub. Date: May 18, 2006

(54) Integrated idea management method and software with protection mechanism

(76) Inventor: Yaagoub Al-Nujaidi, Dhahran (SA)

Correspondence Address: ALBERT B. KIMBALL, JR.;BRACEWELL & PATTERSON L L P, 711 LOUISANA SUITE 2900, HOUSTON, TX, 77002, US

(21) Appl. No.: 10/990,650

(22) Filed: Nov. 17, 2004

(51) Int. Cl. G06Q 99/00

(52) U.S. Cl. 705/1

(57) ABSTRACT

An idea management system for a company or other entity is implemented in a computer network that can be accessed from employee work sites. The system has a pre-defined workflow and built in security process. Submitters of ideas and those authorized to review the submission are electronically notified about the review and evaluation process as it proceeds. Employees submit their ideas and documents explaining the ideas directly to the system. An established review group or committee reviews and otherwise processes the submitted ideas. Status records of implementation of approved ideas are maintained for monitoring purposes.

### BACKGROUND OF THE INVENTION

1. Field of the Invention

The present invention relates to a computer-implemented data management system to collect, manage and allow the evaluation of information regarding ideas, suggestions and improvements on behalf of an organization or entity.

2. Description of the Related Art

Many organizations have relied upon suggestion box systems to gather ideas, suggestions or improvements from their employees. However, these systems often suffered from a number of common shortcomings. For example, because suggestion box systems were not usually focused on specific business goals, suggestion box systems have tended to attract a small volume of generally low-quality ideas or minor improvements. Once an employee submitted an idea, he or she usually never learned what became of it. As a result, employees often became skeptical of the benefit of such a system and would no longer contribute their ideas to the program. Paper-based suggestion box systems also made it hard to ensure that all ideas were evaluated on a timely basis and a consistent manner.

In an attempt to overcome the foregoing problems with paper-based suggestion box systems, a number of software systems have been developed. Various software is available in the literature provided by major vendors for these management applications, which were generally what has been known as knowledge management systems. Examples of such products include: idea management software from BrainBank, Inc. of Dorval, Quebec, Canada; eThink® from Kepner-Tregoe, Inc. of Princeton, N.J.; IdeaBox from Php Outsourcing of Budapest, Hungary; IdeaValue from ideavalue.com of Issy Lesmoulineaux, France; Imaginatik from Imaginatik of Box, Mass; PRISM Ideas Management from ISDE of Gig Harbor, Wash.; and Target Idea Management for mySAP of Sonnenweg, Germany. Nevertheless, many organizations that have implemented knowledge management systems are finding it hard to measure their bottom-line impact.

### SUMMARY OF INVENTION

Briefly, the present invention provides a new and improved computer-implemented method of obtaining and managing information regarding ideas for an entity. According to the method, computer information is received from a submitter concerning an idea. The information includes an identification of the submitter; a categorization, title and description of the idea; a description of benefits from the idea; and identification of a review organization in the entity which is to be responsible for assessing and taking action on the idea. The received information from the submitter concerning the idea is then stored in a memory; and the stored information concerning the idea is then electronically transferred to members of the review organization for assessing the idea. The stored information concerning the idea is then electronically transferred to persons designated to vote on accepting the submitted idea. Votes on the submitted idea are then received electronically from the persons designated to vote. The stored information is also electronically transferred to evaluators designated by the entity to evaluate the feasibility of the idea. Electronic indications of the feasibility evaluations of the idea are received from the evaluators, and the submitter of the idea is then electronically notified of the electronic votes and feasibility evaluations of the idea.

The present invention also provides a data processor which performs the processing steps according to the present invention and obtains and manages information regarding ideas to an entity. The present invention further provides a computer program product in the form of machine-readable instructions for causing the processor to perform the processing steps according to the present invention.

To better understand the characteristics of the invention, the description herein is attached, as an integral part of the same, with drawings to illustrate, but not limited to that, described as follows.

### BRIEF DESCRIPTION OF THE DRAWINGS

A better understanding of the present invention can be obtained when the detailed description set forth below is reviewed in conjunction with the accompanying drawings, in which:

FIG. 1 is a flow chart illustrating the process of operation of the idea management system according to the present invention.

FIG. 2 is a schematic diagram of an example computer network in which the idea management system of the present invention is implemented.

FIG. 3 is an illustration of a screen display of the main interface or home page presented to a user during operation of the present invention.

FIG. 4 is an illustration of a screen display of an idea entry screen or page presented to a user during operation of the present invention from the main interface of FIG. 3.

FIG. 5 is an illustration of a screen display of a menu of idea viewing options available to a user from the main interface of FIG. 3.

FIG. 6 is an illustration of a screen display of a subscribe ideas screen or page presented to a user during operation of the present invention from the main interface of FIG. 3.

FIG. 7 is an illustration of a screen display of a search ideas screen or page presented to a user during operation of the present invention from the main interface of FIG. 3.

FIG. 8 is an illustration of a screen display of an idea details screen or page presented to a user during operation of the present invention from the main interface of FIG. 3.

FIGS. 8A, 8B, 8C, 8D 8E, 8F and 8G are illustrations of graphic user interface icons available in connection with the idea details screen of FIG. 8.

FIG. 9 is an illustration of a navigation tool bar portion of a screen display accessible to authorized invention reviewers according to the present invention from the main interface of FIG. 3.

FIG. 10 is an illustration of an example screen display of a list of submitted ideas accessible to authorized invention reviewers according to the present invention from the navigation tool bar of FIG. 9.

FIG. 11 is an illustration of an example screen display of a submitted idea page or screen accessible to authorized invention reviewers according to the present invention from the navigation tool bar of FIG. 9.

FIGS. 11A, 11B, 11C, 11D, 11E, 11F, 11G, 11H, 11I, 11J, 11K, 11L, and 11M are illustrations of graphic user interface icons available in connection with the submitted idea screen of FIG. 11.

FIG. 12 is an illustration of a screen display or window accessible to authorized invention reviewers of an invention review group or committee according to the present invention.

FIG. 13 is an illustration of a screen display of a feasibility rating chart or window accessible to authorized invention reviewers according to the present invention from the navigation tool bar of FIG. 9.

FIG. 14 is an illustration of a screen display of a net projected value interface window or chart accessible to authorized invention reviewers according to the present invention from the navigation tool bar of FIG. 9.

FIG. 15 is a screen display of reporting options available to authorized invention reviewers according to the present invention from the navigation tool bar of FIG. 9.

FIGS. 16, 17, 18, 19, 20, 21, 22 and 23 are screen displays of example reports available from screen display of FIG. 15 to authorized invention reviewers according to the present invention.

FIG. 24 is a screen display of system maintenance and housekeeping options available to authorized system administrators according to the present invention.

FIG. 25 is a screen display of system maintenance options available to invention management committee members according to the present invention.

FIG. 26 is a screen display of system security functions available to authorized system administrators according to the present invention.

FIG. 27 is a screen display of example system housekeeping functions available from the screen display of FIG. 23 to authorized system administrators according to the present invention.

FIGS. 28, 29, 30 and 31 are screen displays of example system management functions available from the screen display of FIG. 27 to authorized system administrators according to the present invention.

FIG. 32 is a screen display of a statistics report control function available according to the present invention.

FIGS. 33, 34 and 35 are screen displays of example reports available to authorized persons from the screen display of FIG. 27 according to the present invention.

To better understand the invention, we shall carry out the detailed description of some of the modalities of the same, shown in the drawings with illustrative but not limited purposes, attached to the description herein.

### DETAILED DESCRIPTION OF THE PREFERRED EMBODIMENTS

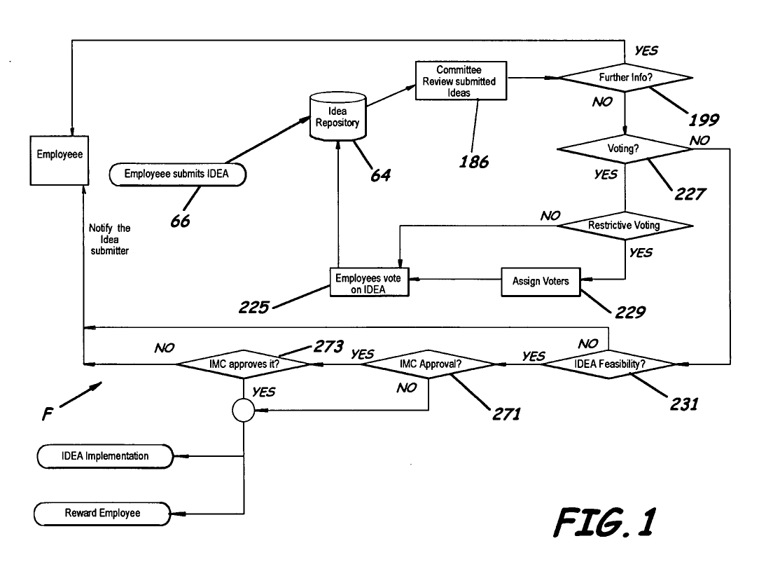

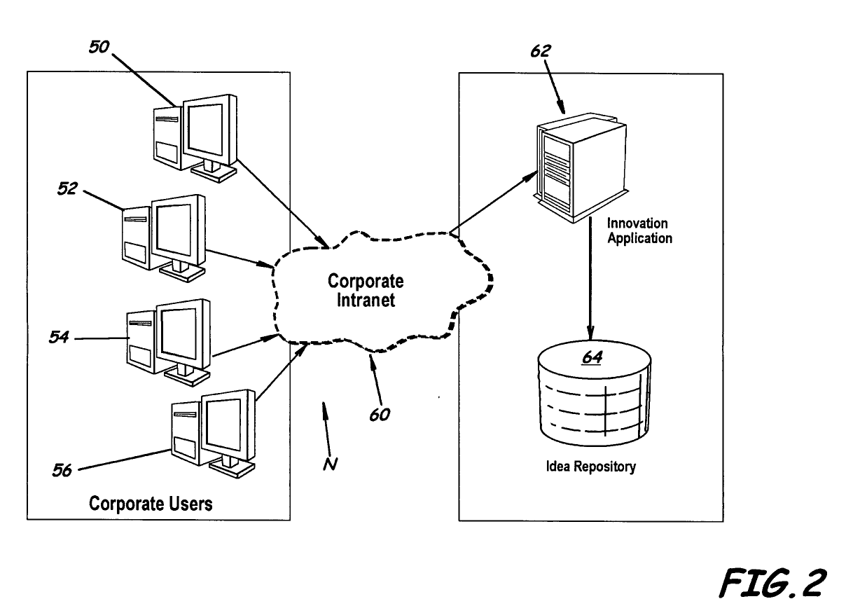

In the drawings, the letter F (FIG. 1) designates generally a high-level flow chart of a computer implemented process for an idea management system implemented according to the present invention in a computer network N (FIG. 2) for a computer on behalf of a company or other enterprise, body, association or other group or organization. According to the present invention, these various types of groups or organizations are each referred to as an entity. The flow chart F allows several groups or individual users of the invention management system to interact with the system of the present invention. The type of users include employees or other authorized contributors, users or sources to submit ideas, suggestions, or improvements, hereinafter referred to as ideas in general, for evaluation, review and processing. Another category of users of the system according to the present invention are groups of authorized employees or designated persons who are formed into groups or committees, hereinafter referred to for ease of reference as invention management committees, to evaluate ideas according to assigned categories, such as the business groups, administrative groups of users or other categories of users of the network N. Additionally, the users of the system includes one or more system administrators to perform housekeeping, maintenance and reporting control functions with respect to the invention management system.

The computer network N (FIG. 2) in an example embodiment takes the form of a number of workstations as shown at 50, 52, 54 and 56 of any suitable commercially available type of personal computer. The workstations are connected as a part of the network N through an organizational network 60 to a server or server bank, as indicated at 62. The server computer 62 can be a mainframe computer of any conventional type of suitable processing capacity such as those available from International Business Machines (IBM) of Armonk, N.Y. or other source. Other digital processors, however, may be used, such as a laptop computer, or any other suitable processing apparatus. The organizational network 60 may take the form of a local area network (LAN) or a wide area network (WAN). The various ideas and suggestions and the like from the users, as will be set forth, after processing by server 62 in accordance with the present invention are stored in a data memory unit or units, thus forming an idea repository or database 64.

In any case, the processor of the server computer as shown at 62 receives the data concerning the field of interest to undertake the logic of the present invention, which may be executed by a processor as a series of computer-executable instructions. The instructions may be contained on a data storage device with a computer readable medium, as shown, having a computer usable medium stored thereon. Or, the instructions may be stored in memory of the computer 62, in repository 64 or on magnetic tape, conventional hard disk drive, electronic read-only memory, optical storage device, or other appropriate data storage device. The results of the processing are then available on a display as shown at 54 or printer or any other form of output device.

The flow chart of FIG. 1 herein illustrates the structure of the logic of the present invention as embodied in computer program software. Those skilled in the art will appreciate that the flow chart illustrates the structures of computer program code elements including logic circuits on an integrated circuit that function according to this invention. Manifestly, the invention is practiced in its essential embodiment by a machine component that renders the program code elements in a form that instructs a digital processing apparatus (that is, a computer) to perform a sequence of function steps corresponding to those shown.

It is important to note that, while the present invention has been, and will continue to be, described in the context of a fully functional computer system, those skilled in the art will appreciate that the present invention is capable of being distributed as a program product in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links.

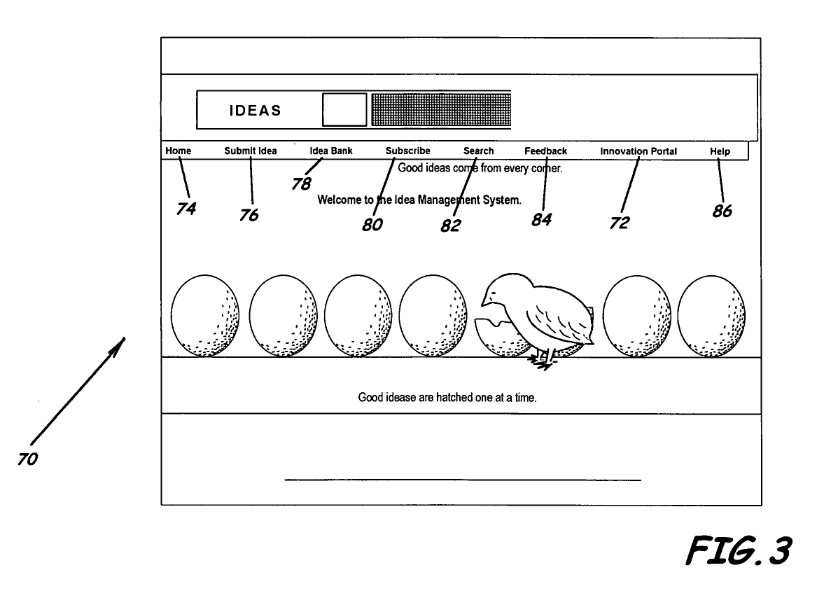

Considering now the operation of the invention management system according to the flow chart F, as indicated at step 66 (FIG. 1), a system user (typically an employee) accesses the server 62 and repository 64 through the network N and summons a main interface or home page 70 (FIG. 3) for entry of data according to the idea to be submitted and processed according to the present invention. The home page display screen 70 has a main system navigation menu 72 including a Home page select identifier or icon 74, a Submit Idea identifier or icon 76 and Idea Bank selector or icon 78, a Subscribe identifier or icon 80, a Search identifier or icon 82, a Feedback selector or icon 84 and a Help selector identifier or icon 86.

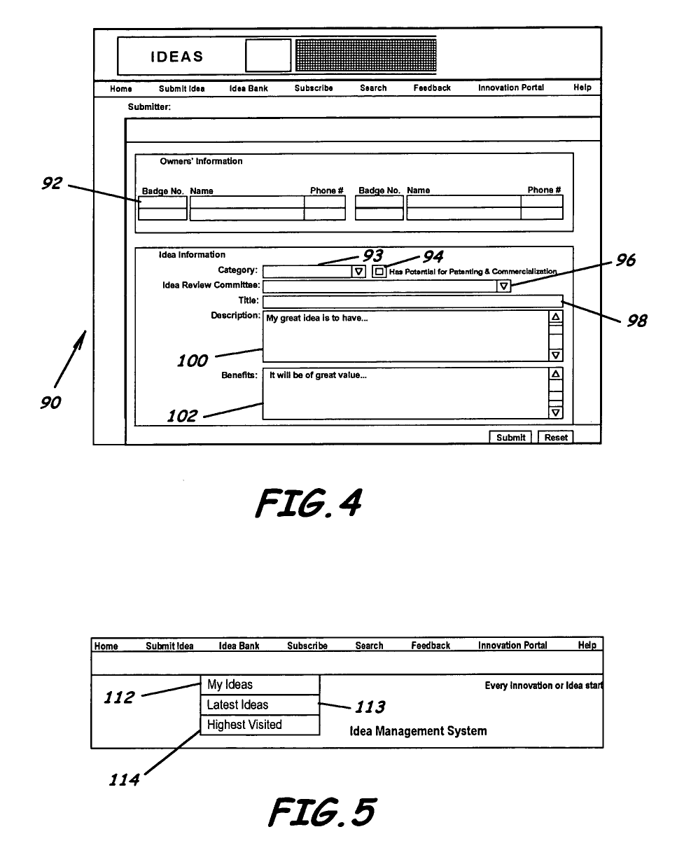

A user desiring to submit an idea selects the Submit Idea icon 76 and is presented with an Idea Entry screen or window 90 (FIG. 4) indicating certain required or designated data entry areas into which the idea submitter or user must enter data for the processing according to the invention management system of the present invention.

The required data entries include an employee identifier number or a badge number, as indicated at 92, where a user enters an appropriate identification number for each contributor to the idea being submitted from the users workstation. Entry of an identifying number causes the name, phone and, if desired, other personal identification data such as mailing address and the like to the entered automatically.

After entry of the identifying information for the various contributors for the idea submitted by the user, the user then enters information with respect to the particular idea of interest, as indicated by appropriately labeled data areas in the Idea Entry screen 90. One of the data entry areas in the Idea Entry screen 90 is a Category data field as indicated at 93 which contains a pull-down listing or menu of a number of categories or fields of various types of areas of ideas from which the user must select. Entry of a category is required for the idea to be submitted. The user then selects an appropriate one of the categories, such as cost savings, performance improvement, area of company operation or the like based on the nature of the idea, organizational structure of the company or entity. An idea potential indicator shown at 94 contains a Yes/No designator or check space where the submitter may make appropriate key action to indicate if the idea is considered to be of a type which should be investigated for evaluation of possible patent protection.

An Idea Review Committee data field as indicated at 96 contains a pull-down menu of the various evaluation committees or groups which the organization has established or implemented for the purpose of reviewing submitted ideas. The Idea Review Committee felt to be appropriate by the user is selected to evaluate the idea. If desired, a default function may select a committee if the user is uncertain of the particular Idea Committee to designate. It is not required that the idea be automatically forwarded to the work group where the user is normally assigned, however. Instead, the submitter is allowed to select the Idea Review Committee deemed most appropriate. The number and types of committees are established by the organization or entity using the invention management system.

A Title data field as indicated at 98 is a free text field area in which the user is prompted to enter a name or descriptive title for the idea being submitted. A Description data field as indicated at 100 is a free text field where the user is prompted enter a summary description of the appropriate elements felt important for the idea being submitted.

A Benefits data field as indicated at 102 is a free text field of a suitable number of characters where the user may state the various business benefits of the idea in terms of cost avoidance, profit generation, cost savings, process improvements and the like. Typically, the user is required to submit at least some minimal description as part of the title, description and Benefits data fields for the idea submission process to continue.

Once the required items of data in the Idea Entry screen are completed at the workstation by the submitter, the data is then transferred to the idea repository or database 64, as indicated in the flow chart F (FIG. 1). The invention management system of the present invention also allows authorized persons to call forth from the idea repository 64 a number of status reports and analytical data about the ideas submitted, as well as the substance of the various ideas contained in the repository 64.

The Idea Bank selector or icon 78 (FIG. 3) on the home page 70 allows a user to access a pull-down menu 110 of (FIG. 5) idea viewing options, which include a My Ideas viewing option indicator 112, a Latest Idea viewing option as indicated at 113 and a Highest viewing option as indicated at 114.

The My Idea menu option 112 when selected presents a user with a view 111 (FIG. 10) of the various ideas previously submitted by the user. The list of ideas submitted by the user as indicated in FIG. 10, contains the following fields:
Title—as shown at 115 contains the data entered in field 98 of Idea Entry screen 90 as submitted or later revised.
Status—as shown at 116—indicates the present status of review of that idea.
Date Submitted—as shown at 118—indicates the original date of submission of the idea.
Number of Hits or Accesses made to this particular submitted idea—as shown at 120.
Submitter or Owner of Idea—as shown at 122—contains the data entered in field 92 of Idea Entry screen 90.
Description for the particular Idea—as shown at 124—contains the data entered in field 100 of Idea Entry screen 90.

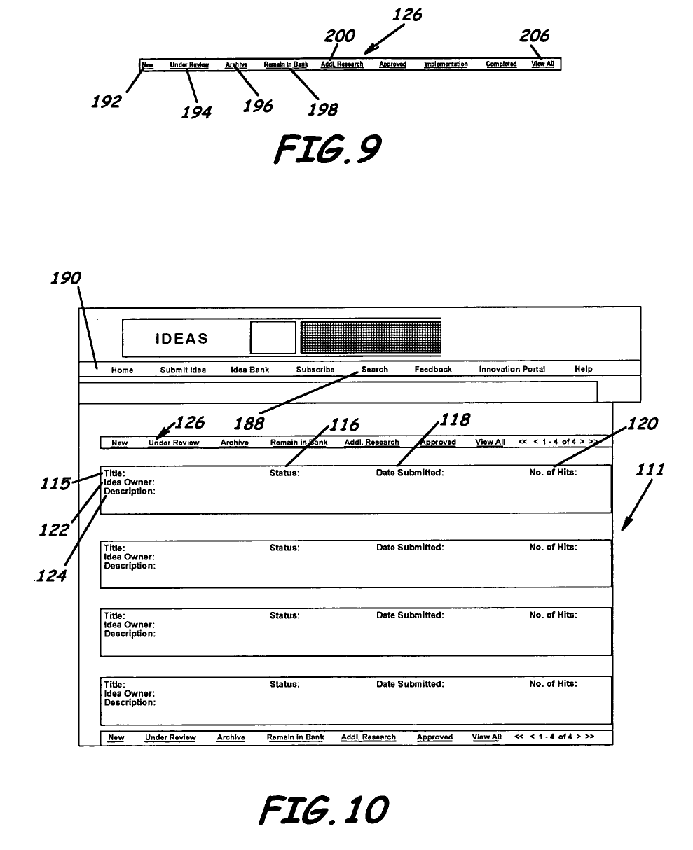

The status indicator 116 for each idea displayed under the Idea Menu option is recognizable by a suitable identifier, such as by color, based on a legend bar 126 (FIGS. 9 and 10) at the top of the page. In this way, the progress of an idea can be easily followed. There are four statuses and each has a separate identifier legend or color. The four statuses are:
New—identifies an idea which has been recently submitted
Under Review—indicates that a committee is reviewing the idea for clarity and possible implementation, as will be set forth below.
On Hold—indicates the idea is being held as part of the reviewing process for further discussion
Approved—indicates the idea has been accepted by the appropriate invention review or management committee

The users may also click on the various status identifier legends for the various status of ideas to filter the list of ideas submitted by that person according to the particular idea status selected. The user may also step through the various lists by making appropriate computer entry on the next, previous, first or last links in the status bar 126.

If more details are required about any particular one of the ideas presented on screen or view 111 during the Idea Menu option, the user may make appropriate notation or click on the Title 98 of the idea to open an Idea Detail page 130, or may click on the icon next to the Title 114 to open an Idea Detail page 130 in a new browser window. During the Idea Menu option, if the idea has attachments, a View Attachments icon 117 (FIG. 8C) is shown and may be accessed to view the idea attachment.

The Latest Idea menu item viewing option 113 when selected presents a user with a view of a list of the latest ideas which have been submitted by the user or others. The list of latest ideas submitted is of the same appearance as the screen display 111 of FIG. 10, listing instead latest ideas submitted regardless of submitter, rather than ideas originated by a particular user or submitter. Accordingly, the list of latest ideas shows the same types of fields, status indicators and status identifiers as shown at 111 in FIG. 10. Similarly, users of the system have the same scanning and viewing options for the Latest Ideas submitted list as those described above for the My Ideas list.

The Highest Visited viewing option 114 when selected presents a user with a list of the ideas in repository 64 based on the numbers of hits or visitors who browse the various individual ones of the ideas. The ideas are sorted in descending order beginning with the most visited idea. The list of highest visited ideas is of the same appearance as the screen display 111 of FIG. 10, listing ideas in order of the number of times visited, again regardless of submitter. Thus, the list of highest visited ideas shows the same types of data fields, status indicators and status identifiers as those shown at 111 in FIG. 10. Similarly, users of the system have the same scanning and viewing options for data regarding the Highest Visited items menu 114 as that previously described for the My Ideas menu item 112 and Latest Idea menu item 113.

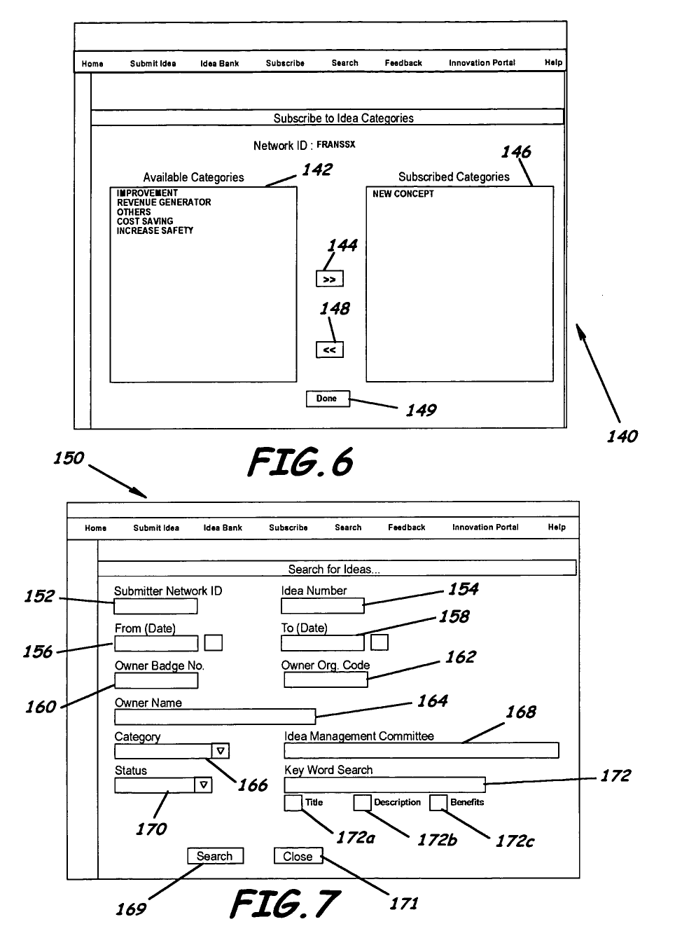

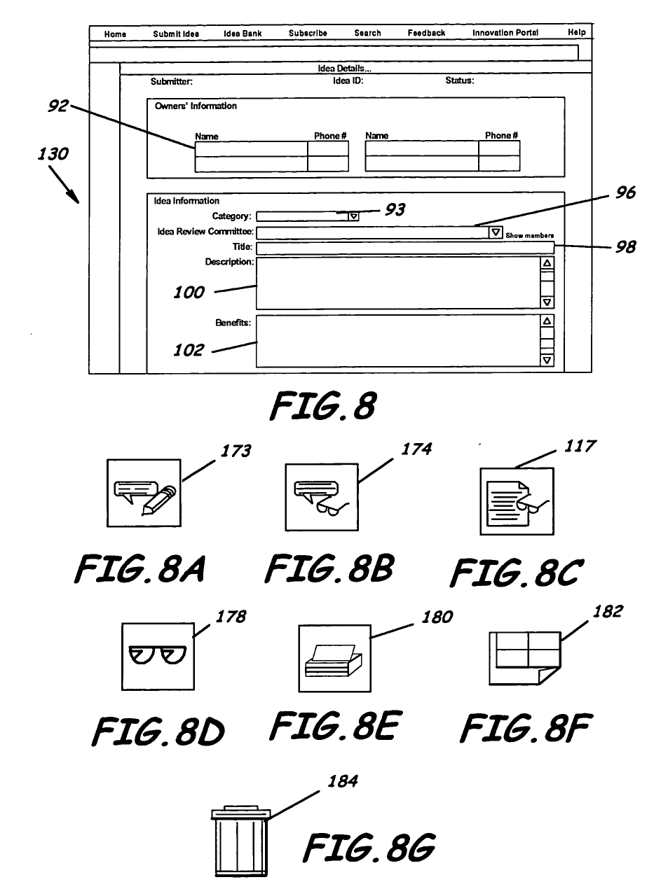

The Subscribe icon or identifier 80 (FIG. 3) on the Home page 70 allows a user to access a Subscribe Ideas window or screen display 140 (FIG. 6) and thus subscribe to and receive notification via electronic mail or message at those times that an idea in one or more of the categories is submitted. The categories available under this feature are indicated in a window 142 on screen display 140 and correspond to those in the Categories data field 93 discussed above. Subscription to a category is made by clicking on one or more of the desired categories in Available Categories window 142 and activating a subscribe transfer button indicator 144 on the display screen to move the selected categories to a Subscribed Categories window 146. A user may unsubscribe by clicking on one or more of the Subscribed Categories in window 146 and activating an unsubscribe transfer button 148 on the display screen 140. A Done or Exit indicator 149 is activated by a cursor of the user's workstation to return to Home page 70 from Subscribe Ideas display 140.

The Search icon or identifier 82 (FIG. 3) on the home page 70 allows a user to access a Search Ideas window or screen display 150 (FIG. 7) and thus search for and locate information about a specific idea by search various criteria. It is to be again noted that a user may access ideas in repository 64 from all sources, and not just those of the user. The user may search according to one or more of the criteria presented on the window 150. The criteria available for search under this feature as indicated in FIG. 7, are user identification number or code by user identification number field for network 60 as indicated at 152; Idea number as indicated by a data entry field at 154; and date of Idea submission as indicated by a From date entry field 156 and To date entry field 158. The Search Ideas feature allows a user to search for all Ideas submitted or after the From date in field 156; on or before the To date in field 158, or during the time between the two dates entered in fields 156 and 158.

A data entry field 160 allows a user to search for ideas by employee identification or badge number, while a data entry field 162 permits searching by organization or work group. Similarly, a data entry field 164 allows a search based on the submitter or owner's name. Data entry field 166 allows searches to be made based on invention Category like data field 93 discussed above, while data entry field 168 allow searches based on one of the Idea Management Committee, corresponding to those in data field 96. A data entry field 170 allows a search to be made of ideas in repository 64 according to the Status assigned to ideas. A date entry field 172, as discussed above, allows for entry of free text of a certain number of characters so that a text search of submitted ideas containing the indicated text words or characters in an identified Title—indicator 172a, Description—172b or Benefits—172c can be located. Search indicator 169 and clear indicator 171 permit control of Search Idea functions by a user's cursor. The Feedback selector or icon 84 allows a user to send to the system or network administrator comments, notes, etc. regarding the operation of the system of the present invention.

The Idea Details screen 130 (FIG. 8) is provided to allow user/submitters of ideas to view and update the information contained in repository 64 which names the submitter as one of the originators or owners of the idea. The information on Idea Details screen 130 corresponds to that entered by Idea Entry Screen 90 and thus bears like reference numerals.

If the user is the submitter of the idea, then that user can update idea information, except the assigned management committee, if the idea status is new, meaning it has not yet begun the further processing steps shown in FIG. 1. The user can modify Idea owners and Idea category if the idea status is other than new. The user can also delete the idea if it is new, and upload attachments to the idea.

If the user accessing the network N is a member of the management committee, then that user can update the idea category, transfer the idea, change status of the idea, send invention management committee comments, view attachments, add comments, view comments, enter feasibility values, view idea history, and print the idea.

If the user is none of the above, then that user can only view the idea, add comments, view attachments, view comments, view idea history, and print the idea.

The invention management system of the present invention provides a number of graphic user interfaces or icons (FIGS. 8A through 8E) displayed on Ideas detail server 130 (FIG. 8) for users of the system to edit, review, comment on, modify or take other actions regarding ideas contained in the repository 62.

An Add Comments icon 173 (FIG. 8A) allows any user who is permitted access to an idea to add one or more comments about the submitted idea by entering the comments into a description field and again clicking the Add Comments icon 173.

A View Comments icon 174 (FIG. 8B) when selected allows a user of any of the types mentioned above to view comments about a specific idea. The data display on selection of the View Comments icon 174 includes the comment description and the date of submission of that comment to the system.

The view attachments icon 117 (FIG. 8C) when selected by a user allows the user to view any attachments to the Idea Display screen 130. The data display in such an event lists attachments uploaded and relevant data about the attachment such as file name, type, size and date submitted.

A View Idea History icon 178 (FIG. 8D) when selected allows a user to monitor or track changes in an Idea. Users can track changes based on fields, such as Idea status, updating date, by whom updated, and comments. This feature also allows tracking of the transfer process by viewing dates of transfers, by whom transferred and to and from whom the idea was transferred.

A Print Idea Detail icon 180 (FIG. 8E) when selected allows printing of the idea currently on Idea Display screen 130 or of any comments about that idea.

An Upload Attachment icon 182 (FIG. 8F) when selected allows the idea submitter to include additional documentation about or in support of the idea currently on Idea Display screen 130. Attachment and upload of documents then may be performed in any of several conventional manners. Finally, a Delete Idea icon 184 (FIG. 8G) when selected allows an idea submitter to delete an idea in the new idea status, as defined above, at any time prior to an Idea Management Committee member assuming responsibility of the idea.

After an idea is entered into the repository 64, it is available as a submitted idea for review by an invention review group, also termed an invention management committee or IMC, as indicated at step 186. During step 186, the submitted ideas view (FIG. 10) is displayed, and a My IMC's icon 188 of a navigation tool bar 190 is selected. The navigation tool bar 190 is available for presentation only on the display 111 of authorized members of an invention review group or IMC. A listing of ideas assigned to that invention review group are then retrieved and displayed as the submitted ideas view 111. The format and content of the ideas listed at this time are like those described above for the menu options 112, 113 and 114. Committee members can then review, process, edit or otherwise the assigned ideas present during the ideas view using the status tool bar 126 (FIG. 9).

A New icon 192 of status bar selects the most current idea submissions. An Under Review icon 194 is used to designate those ideas which are designated to be present under review. An Archive icon 196 is used to designate those ideas that have been reviewed but are not approved, but rather to be stored for later reference. A Remain in Bank icon 198 is used to designate an idea to be retained within the active list for further review, comment, feedback or other action. As indicated at step 199 in the flow chart F, if further information is required, the submitter can be so advised by e-mail or other form of electronic message.

An Additional Research icon 200 is used to indicate that additional research is required before a determination can be made for the idea at issue. An approved icon 201 of the status bar 126 is used to indicate that the submitted idea has been approved. An Implementation icon 202 is used to call up a listing of those ideas that are being implemented. A Completed icon 204 is used to call up a listing of those ideas which have completed processing through the system of the present invention. A View All icon 206 is used to call up a listing the ideas assigned to a particular IMC.

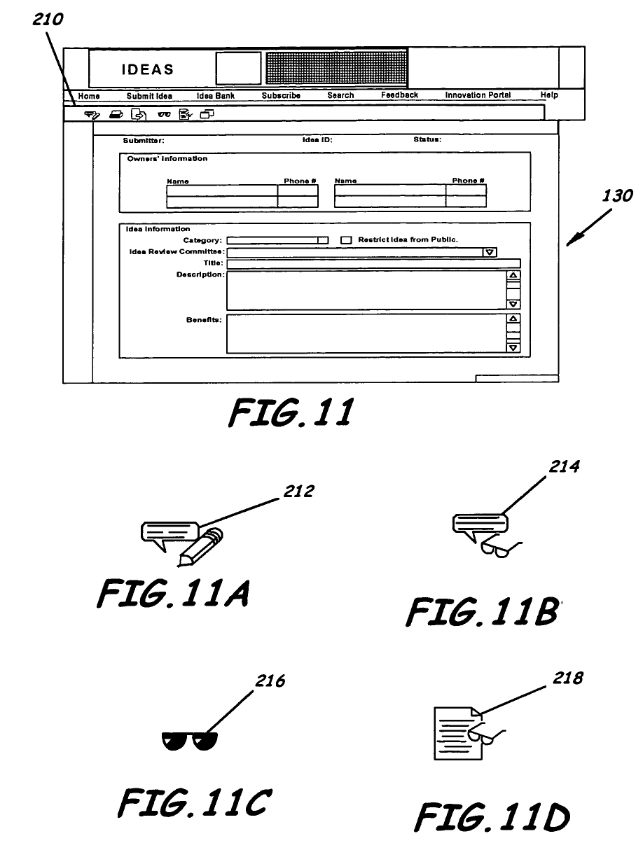

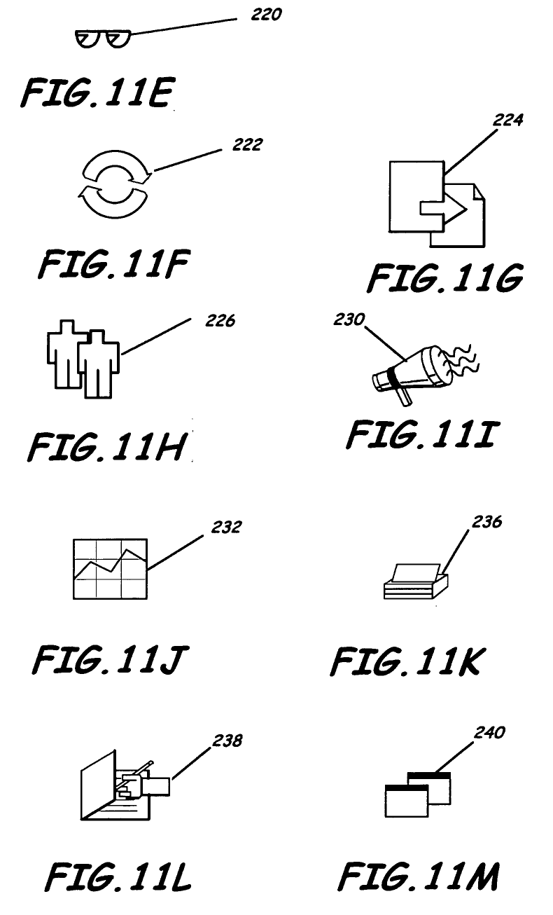

To select a particular idea for review during step 186 (FIG. 1), an IMC member clicks on the Title field 115 of idea display 111 (FIG. 10), which calls forth from repository 64 and displays an Idea Detail screen of the type shown at 130 (FIG. 11). The Idea Detail screen 130 for authorized IMC members has a navigation tool bar 210 containing a number of graphical user interfaces or icons (FIGS. 11A through 11M, inclusive) which are used in the idea review process 186. This page will be shown if the user has an administrative privilege on the system. If a user with administration privilege clicks on it, the administration page will be shown. Administration page is the place where an authorized user with administrative privilege can manage and maintain the main application information and security and obtain reports.

During the idea review process as indicated at 186, the reviewing committee reviews and analyzes the contents of the idea display screen 111 (FIG. 10), the Idea Details screen 130 (FIG. 11), and any attachments, comments from other earlier idea reviewers, and any other comments available.

During the review process, the reviewer uses the icons (FIGS. 11A-11M) accessible through the navigation tool bar 210. The reviewer selects an Add Comments icon 212 (FIG. 11A) on tool bar 210 to open a page for addition of comments by that reviewer which are then stored with other data in repository 62 relating to that particular idea. A View IMC comments icon 214 (FIG. 11B) on tool bar 210 allows a reviewer access for viewing comments made earlier by other IMC members. A View Comments icon 216 (FIG. 11C) allows a reviewer to retrieve and view comments made by other persons than IMC members. A View Attachments icon 218 (FIG. 11D) allows a reviewer to open links to attachments to the Idea Details for view or download. A View Idea History icon 220 (FIG. 11E) allows a reviewer to track and be provided with details about status changes and transfers regarding the idea.

A Change Status icon 222 (FIG. 11F) allows a reviewer to assign or change the status of the idea to one of those as shown by the status indicators shown in FIGS. 9 and 10 and described above. A Transfer Idea icon 224 (FIG. 11G) opens an interface to permit the idea to be forwarded to a designated entity, department or group in the invention management system, along with any applicable comments.

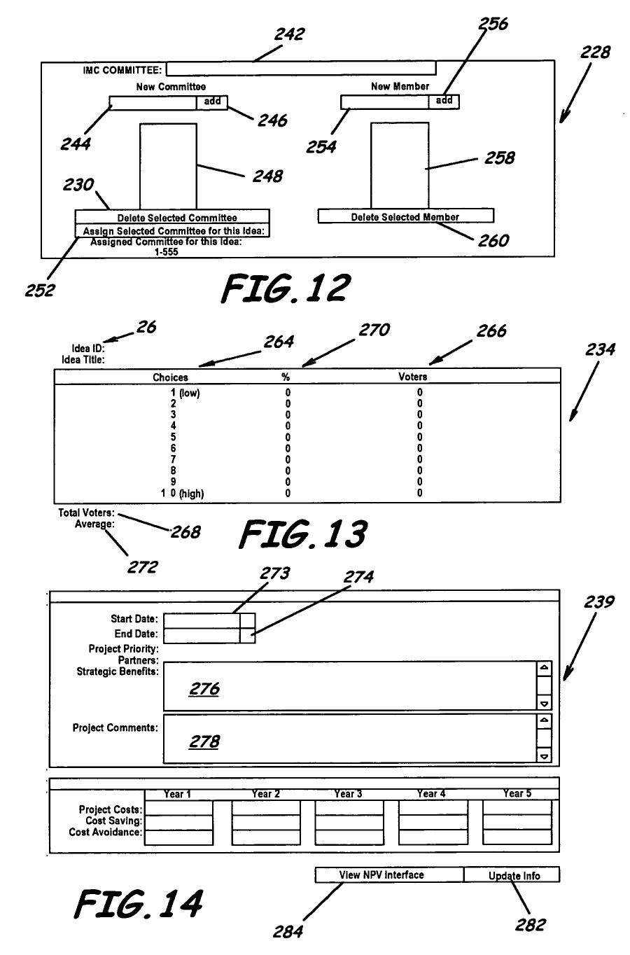

An Assign Voting Committee icon 226 (FIG. 11H) which is used during a step 227 in flow chart F opens an interface to a window or display 228 (FIG. 12) that allows an IMC reviewer or manager to create a committee, assign members to that committee and select a voting committee to vote on the idea. Selected or assigned members are notified via the network 60 of their selection. If, as indicated at step 229, restrictive voting is desired, window 228 may be used for purposes of assigning the restricted data of voters. After voters are assigned, they are modified and permitted to vote as indicated at 225 on the ideas sent them.

A Feasibility icon 230 (FIG. 11I) opens an interface that allows the reviewer to rate the feasibility of the idea based on some suitable rating scale. A step 231 indicates this procedure. An example is a scale of from 1 to 10, ranging from not feasible to very feasible. The ability to add comments is also provided.

A View Feasibility icon 232 (FIG. 11J) opens an interface and allows a reviewer to view through window 234 (FIG. 13) feasibility ratings given by others for the particular idea. A Print icon 236 (FIG. 11K) allows a reviewer to print the idea bring reviewed or comments concerning that idea.

A View NPV (or Net Projected Value) icon 238 (FIG. 11L) opens an interface 239 (FIG. 14) for completed and implemented ideas, as described above, in the repository 64 for completed and implemented ideas, to display value associated with the idea. A Modify NPV icon 240 (FIG. 11M) opens the interface 240 for implemented ideas, as described above, in the repository 62 to modify or adjust the values associated with the idea. Comments may be added, information about benefits provided, times and dates revised, costs and savings figures updated and the like.

The window or display 228 (FIG. 12) is opened as an interface when the Assign Voting Committee icon 226 (FIG. 11H) is selected by an authorized user. The interface 228 contains a committee identifier window 242 through which the currently selected one of a list of established invention management committee is presented. The interface 228 also contains a window 244 through which a name of a new committee may be entered, and established by selection of an ADD indicator 246. An area 248 displays a listing of available established invention management committees, which can be scrolled down by a user with access to the display 228 so that the committee can be accessed.

An indicator area 250 on display 228 permits an authorized user to delete a selected committee displayed in area 248, while on indicator area 252 permits such a user to assign an idea to be assigned to the selected committee displayed in area 248.

The interface 228 also contains a window 254 through which a name of a new member may be entered for the selected committee displayed in area 248 and added by selecting an ADD indicator 256. A window 258 displays a listing of current selected members of the committee displayed in area 248. The listing of current selected members display in window 258 may also be scrolled down. An indicator 260 may be selected by an authorized user to delete individual ones of the selected members in window 258.

The window 234 (FIG. 13) associated with the View Feasibility icon 232 (FIG. 11J) displays for an idea identifier in a number and title area 262 the available choices of feasibility ratings to members of the invention management committee assigned the identified area, as indicated in a column area 264. A column area 266 displays a running total of the number of votes for each of the available feasibility ratings, and an area 268 indicates a cumulative total of the number of votes made. A column 270 displays a relative percentage for each of the available feasibility ratings of the total number of votes, and a display area 272 displays an average value of the feasibility ratings assigned. At such time as an idea under review meets requisite feasibility criteria, the idea is transferred as indicated at step 271 to determine if the assigned invention management committee has voted approval. If committee approval is not required, the idea is available for implementation and if applicable on appropriate award given to the submitter or submitters. As indicated at 273, if the voting committee approves the idea, it is available for implementation and the submitter(s) may be rewarded. If the idea is not approved, the submitted is notified by e-mail or other suitable electronic message.

The window 239 (FIG. 14) associated with the View NPV icon 238 (FIG. 11L) includes windows 273 and 274 for entry of start and end dates, respectively, for feasibility evaluation intervals. Areas or windows 276 and 278 are provided for entry of information about strategic benefits or project comments, respectively. Area 280 in window 239 contains windows for entry of project cost, cost saving and cost avoidance figures for a number of years over which net projected value computations are made. A button area 282 on selection allows a user to update the information displayed in window 239 and a button area 284 on selection allows a user to calculate the net projected value based on the figures entered in area 280.

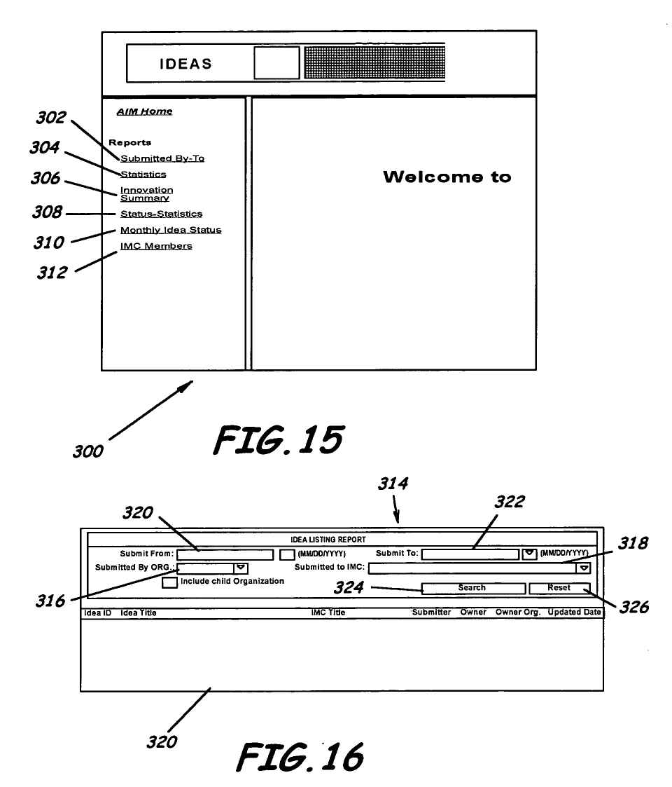

The invention management system of the present invention provides a number of reporting options. A display 300 (FIG. 15) presents a listing of reports available for display and printout. The available reports include a Submitted By—To report as indicated at field 302 on display 300, a Statistics report as indicated at field 304, an Innovation Summary report as indicated at field 306, a Status-Statistics report as indicated at field 308, a Monthly Idea Status report as indicated at field 310, and an IMC Members report as indicated at 312. The available reports are accessed by selection with a cursor on the respective indicated area of the display 300.

A submitted By—To report screen 314 (FIG. 16) accessed by cursor entry on field 302 of screen 300 displays a listing of ideas submitted by an originating person or group as shown in window 316 to a particular invention management committee as shown in window 318. Windows 320 and 322 allow the report to be limited according to beginning, ending or submission dates. A search button 324 causes a search to be made based on data entered the windows of the report screen 314, and a reset button 326 is provided to clear the display screen for presentation of results of a further search or searches. An area 328 displays the search results, indicating ideas within the areas searched by identification number, title, title of assigned invention management committee, submitter, submitter group and date of most recent version or revision of the idea.

A Statistics report screen 330 (FIG. 17) accessible through field 304 display for one or more invention management committees by identification number and code present according to present assigned status by that committee of the submitted ideas assigned to that committee, the cumulative totals of submitted ideas and data available from net projected value calculations or studies.

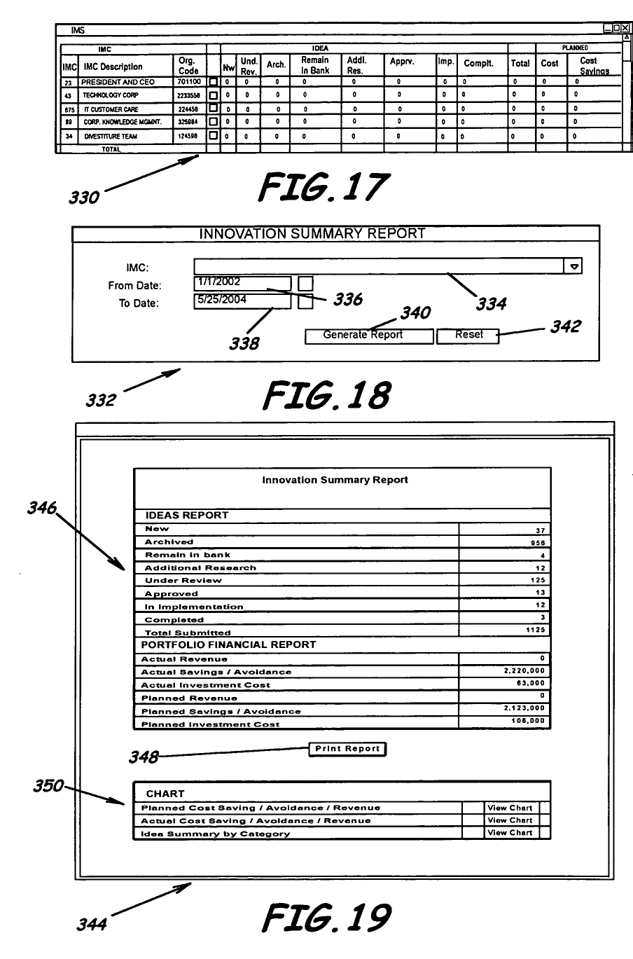

An Innovation Summary report access screen 332 (FIG. 18) accessible through field 306 displays when requested a window 334 for selection of an invention management committee from an accessible pull-down listing, and windows 336 and 338 for entry, if desired, of report beginning and ending dates, respectively. The Invention Summary report is generated by action of a cursor on and area 340 of screen 332 and reset by action of a cursor on area 342.

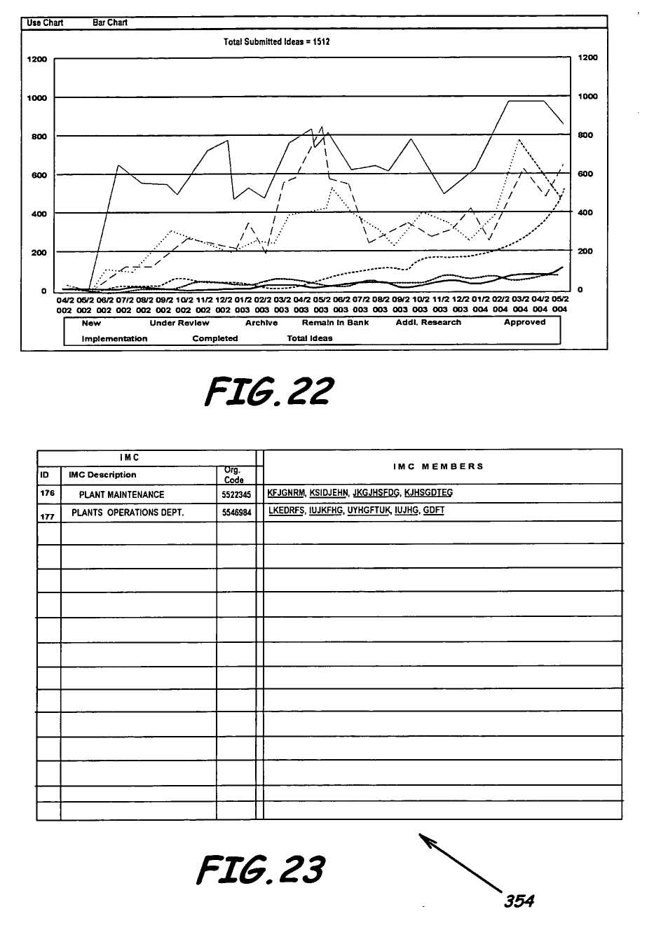

An Innovation Summary report screen 344 (FIG. 19) displays when requested for a selected department or group and over a designated time interval present totals by status of submitted ideas, as indicated at 346, and also financial projections when available. A button 348 when activated by a cursor causes a printed version to be made as a report of the present display contents. An area 350 when accessed by a cursor causes charts, as exemplified in FIG. 22 to be displayed. The display of FIG. 22 is of submitted ideas per month or other time interval by category status, and may be in line chart or bar chart form. The various category counts may be identified by differing colors, symbols or the like from each other. Cost or financial data, whether planned or actual, from the Portfolio Financial Report portion of screen 344 (FIG. 19), may also be displayed in a manner like that of FIG. 22 in line or bar chart form.

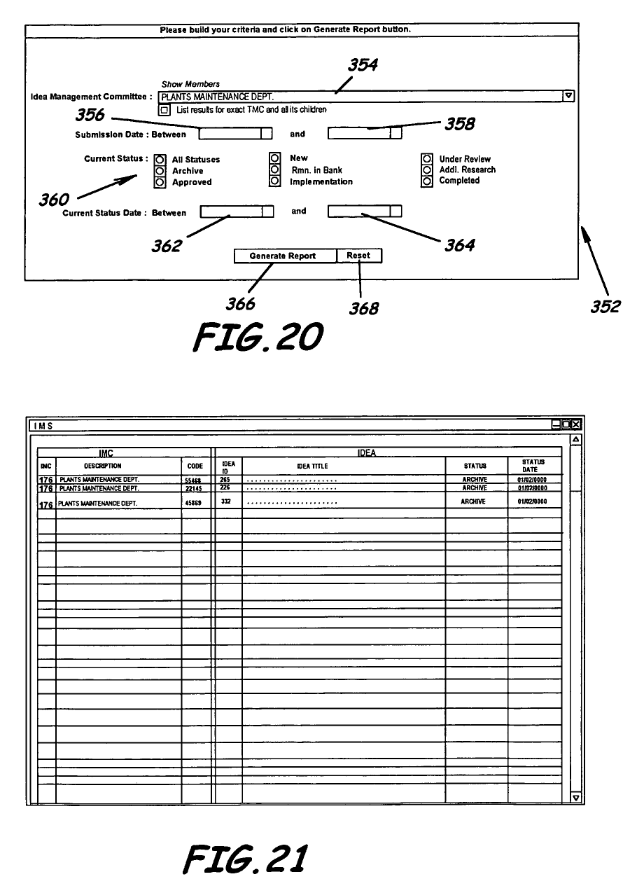

A Monthly Idea Status report access screen 352 (FIG. 20) includes a window 353 for selection of an invention management committee from an accessible pull-down listing. Windows 354 and 355 are provided for entry, if desired, of report beginning and ending dates, respectively. Indicator areas 356 are provided for designation of the ideas by current status or as a cumulative total of all ideas, and windows 357a and 357b are provided for entry, if desired, of beginning and ending report dates, respectively. The Monthly Idea Status report is generated by action of a cursor on area 358a of screen 352 and reset by action of a cursor on area 358b.

FIG. 21 represents an example Monthly Idea Status Report generated on request from screen 352. Information displayed includes invention management committee identifier code and number, title, idea identifier number and title, status as of the status date indicated on screen 352, and most recent status changes.

An IMC Members report screen 359 (FIG. 23) is a display by committee number, name and identifier code of those persons presently assigned to the various invention management committees.

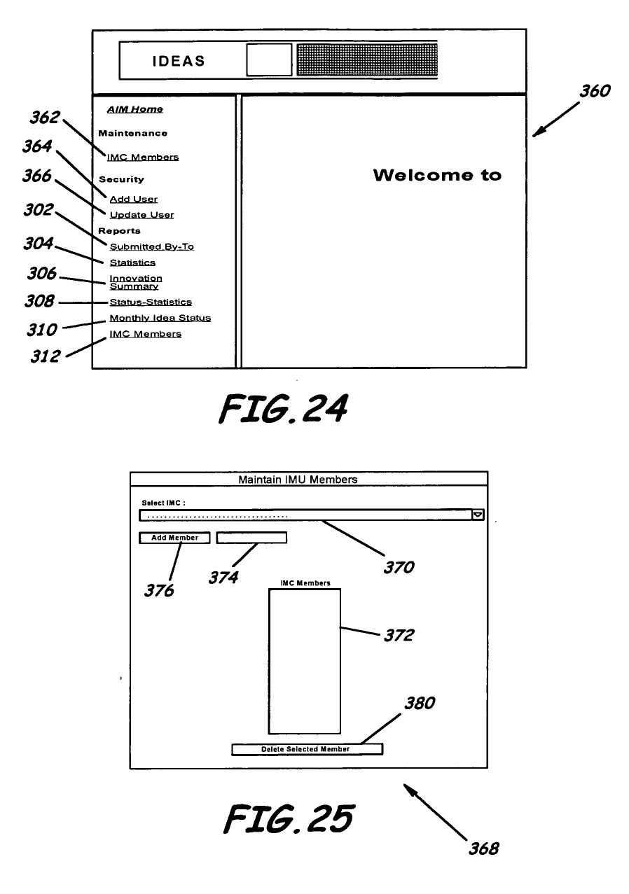

The invention management system of the present invention also provides a number of system housekeeping maintenance and security functions by an invention management committee administrator of the invention management system. The functions are more detailed than those afforded or accessible to the idea submitters and idea committee members. A display screen 360 (FIG. 24) presents a list of reports available to the invention management committee administrator which are like content and structure to those available on display 300 (FIG. 15). Accordingly, like reference numerals are used on display screen 360 for reports like those of display 300.

The functions available from display screen 360 in an IMC Members maintenance function, as indicated at field 362, and Add User and Update User security functions, as indicated at fields 364 and 366.

A display screen 368 (FIG. 25) displays IMC Member maintenance functions on request made through field 362 of display screen 360, and includes a pull-down listing of present invention management committees accessible through a window 370, a window 372 listing present members of the selected committee, a data entry window 374 for entry of the name or code or other designator for a member to be added the selected committee in window 370. A newly entered name in window 374 is added by action of a cursor on an Add Member area 376. Conversely, one or more selected members listed in window 372 may be deleted by action of a cursor on a Delete Selected Member area 380.

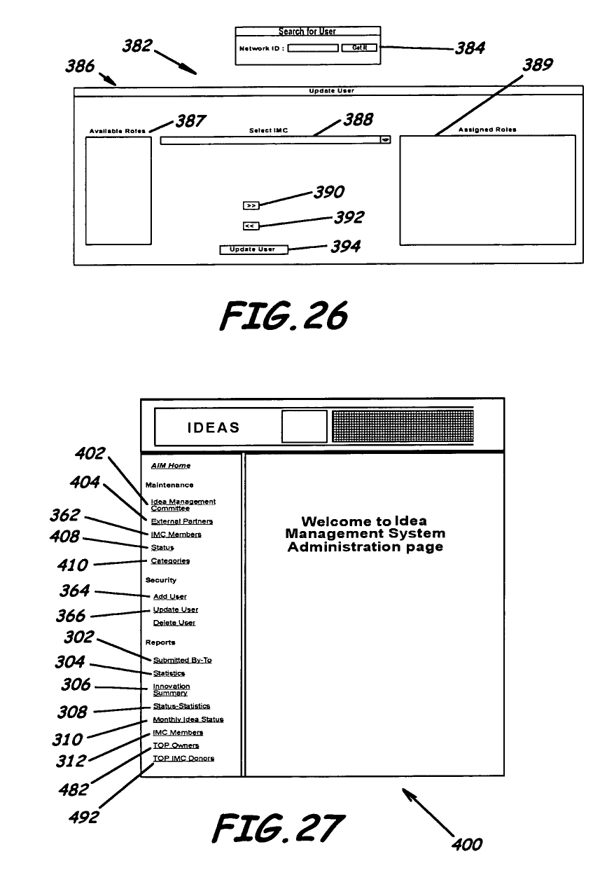

A display screen 382 (FIG. 26), accessible through fields 364 and 366 of screen 360 allows an IMC System administrator to perform system security functions, such as adding users and updating information about current users. A portion 384 of display screen 382 allows entry of a users identification code of the network 60 and presentation of display 386 available roles as indicated at a window 387. Previously assigned rules are displayed in a window 389. A window 388 makes a pull-down listing of invention management committees and presently assigned roles for a designated user. Transfer button areas 390 and 392 allow movement of between available roles and assigned roles for the identified user in order to adjust roles. Invention management committee assignments for an identified system user are adjusted by selection from the listing available from window 388. Selections made for roles and invention management committee assignments are confirmed by action of a cursor on an area 394 of display 386.

The invention management system of the present invention also provides for system administration functions by a system administrator. The functions are more detailed than those afforded to or accessible either to the invention management committee's administrator through display screen 360 or to individual submitters and committee members. A display screen 400 (FIG. 27) presents a list of system maintenance reports and functions available to the system administrator for the network N.

System maintenance functions accessible to the invention management committee administration from display screen 400 include an Idea Management Committee function as indicated at field 402, an External Partners maintenance function as indicated at field 404, and IMC Members maintenance function as indicated at field 362, a Status maintenance function as indicated at field 408 and a Categories maintenance function as indicated at field 410.

The display screen 400 also includes access to security functions for adding, deleting or updating like those available at fields 364 and 366 through display screen 360 (FIG. 24) to Invention Management Committee administrators and descried in the manner set forth above, for this reason, like reference numerals for functions accessible through display screen 400 to those of display screen 360 bear like reference numerals.

Similarly, the display screen 400 also includes access to reporting functions like those available at fields 302 through 312 through display screen 300 (FIG. 15) to Invention Management Committee administrators and described in the manner set forth above. Accordingly, those reporting functions accessible through screen 400 like those described for display screen 300 bear like reference numerals.

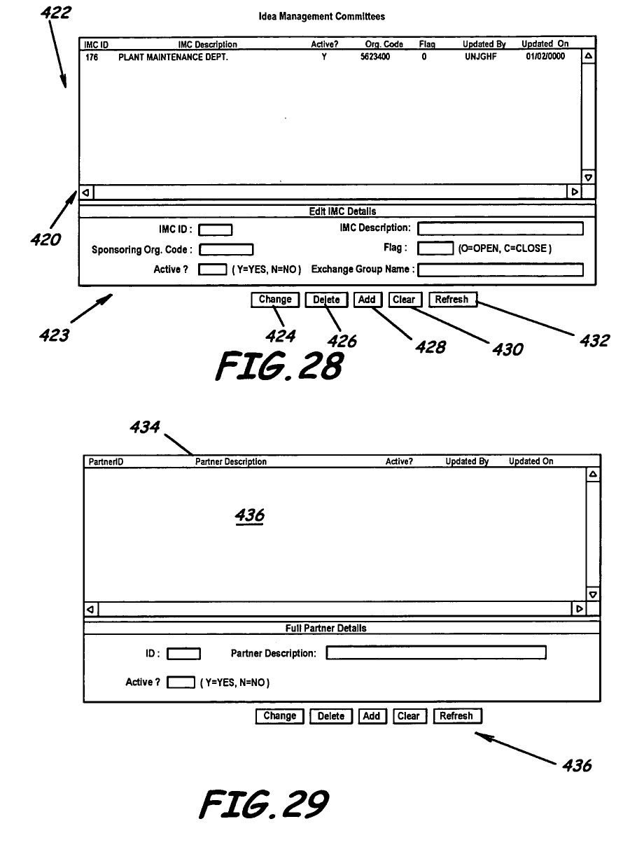

A Manage Idea Committee display screen 420 (FIG. 28) is accessible through the Idea Management Committee function field 402 on screen 400. The display screen 420 provides a section 422 listing identification number and name the various invention management committees now or previously established, as well as an active status indicator, organization code, a flag to indicate whether the committee is open or closed, as well as a display of the date and person making the last update.

The display screen 420 also includes a section 423 containing windows for data entry of information contained in section 422. Display screen 422 also includes control buttons 424, 426, 428, 430 and 432 responsive to a cursor for Change, Delete, Add, Clear and Refresh Control functions to be exercised on the data fields of display screen 420.

A Manage External Partner display screen 434 (FIG. 29) is accessible through the External Partners maintenance function of field 404 on display screen 400. The display screen 434 provides a section 436 listing identification number and description for non-employees authorized by appropriate employee policy to participate in the invention management system, as well as whether those persons are at present permitted to be active members. The section 436 also identifies the name or code of the last update and its date to the Manage External Partners data in depository 64. As indicated at 436, control buttons for Change, Delete, Add, Clear and Refresh functions like those described above for display screen 420 are provided in display screen 434.

The Manage IMC Members function of field 362 on display screen 400 provides access to Assign Voting Committee interface 228 (FIG. 12) and control functions to add, delete or update as described above are made available.

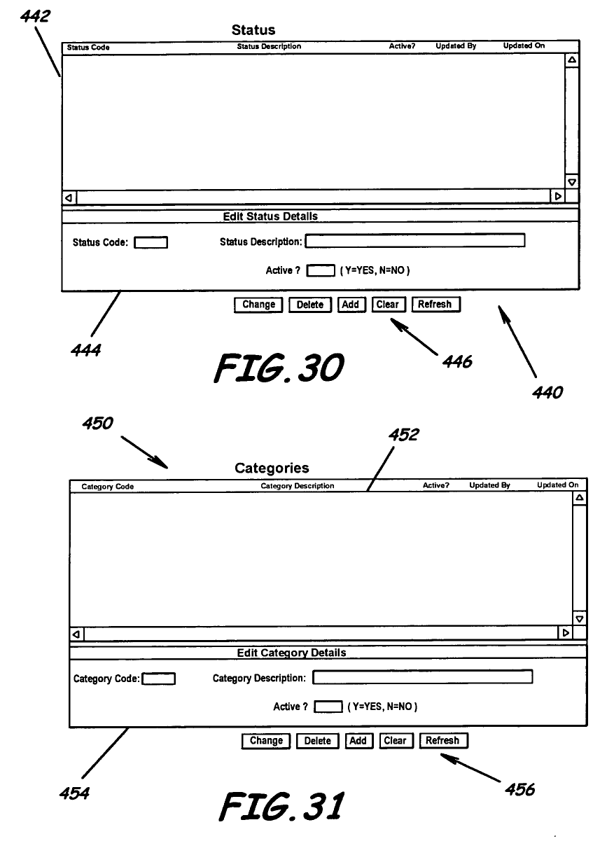

The Manage Idea Status function of field 408 on display screen 400 provides access to an Idea Status interface 440 (FIG. 30). A section 442 of the Idea Status interface 440 provides a display of the present idea status codes, title or description, active/inactive status and the name or code of the person who made the last update and its date to the function. Display 440 also includes a section 444 containing windows for entry of data for display section 442, with control buttons for Change, Delete, Add, Clear and Refresh functions at 446 to be exercised on the data fields of display screen 440 by cursor or the like.

The Manage Idea Categories function of field 410 on display screen 400 provides access to Categories interface 450 (FIG. 31). A section 452 of interface 450 provides a display of the various categories by code, description, active/inactive status and the name or code the person making the last update, and its date to the Categories function. A section 454 of interface 450 contains windows for entry of data for display section 452. As indicated at 456, control buttons are present in interface 450 for Change, Delete Add, Clear and Refresh functions to be exercised on the data provided through windows in section 454.

As has been noted, a number of reports accessible through System Administration page 400 (FIG. 27) in a like manner to that provided to invention management committee administrators through page 300 (FIG. 15), and like reference numerals are used.

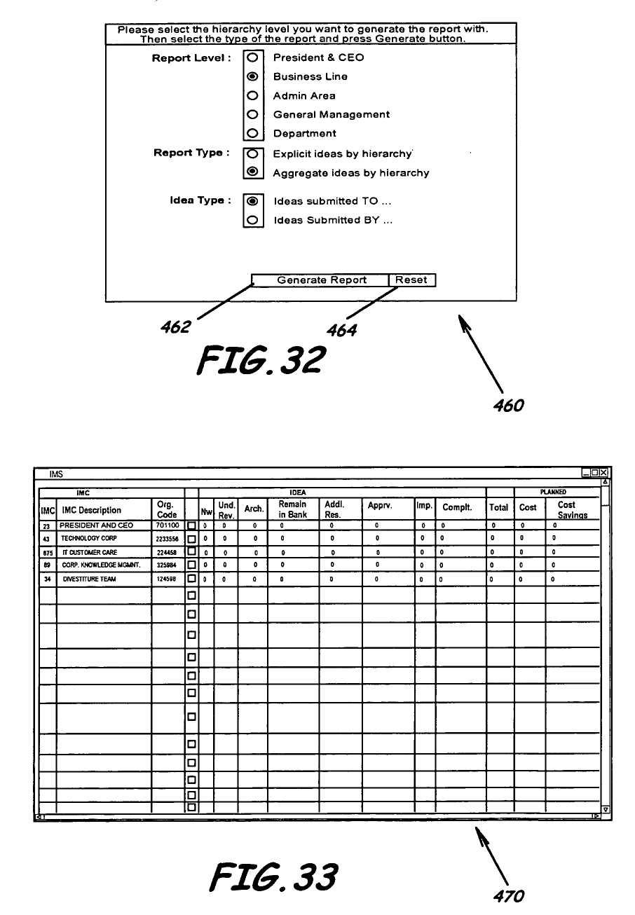

In addition, a display screen 460 (FIG. 32) is presented when the Statistics Report function 304 is selected, permitting the system administrator to select report level and report type as well as whether the idea to be reported are those submitted to, or submitted by a particular or invention management committee. Control buttons 462 and 464 are accessible on display screen 460 to a cursor so that a report can be generated or reset the report function used, respectively. FIG. 33 indicates at 470 an example report of the type designated by the indicated fields Business Line, group or aggregated by hierarchy and invention management code to which submitted.

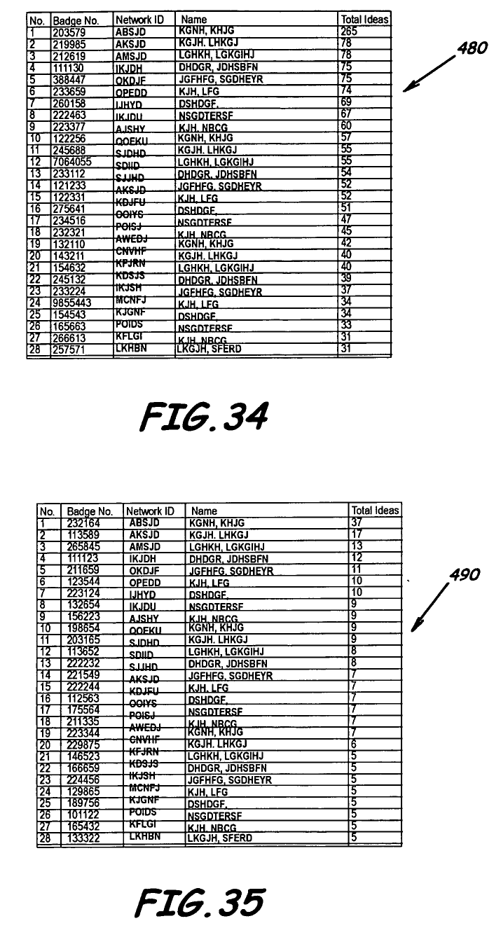

A display screen 480 (FIG. 34) is accessible through a Top Owners Report function field 482 on display screen 400 to report in by total number of ideas submitted? by individual users. The user name, user identifier number and network identifier for network 62 are also present in screen 480, as indicated.

A display screen 490 (FIG. 35) is accessible through a Top IMC Owners Report function 492 on display screen 400 to report the total number of ideas owned? by individual IMC members. The name, employee identifier number and network identifier number for network 64 are also present in screen 490, as indicated.

The Idea management system of the present invention aims at locating rapidly mediocre ones, and to filter them through evaluation, consideration for protection and ultimately to implementation an idea submitter is equipped with appropriate department, unit and company values, visions and priorities so that the idea submitter may focus effort to create maximum value for the company.

Entities can also set up specific campaigns or projects within the software, each one tailored to address a specific business objective—such as reducing costs in a division, or coming up with new ideas for a particular product line. Focused idea development around specific business objectives tends to result in a larger number of high quality ideas. Entities also can customize idea input forms by campaign or project to meet their specific needs.

As can be seen, the present invention provides workflow processes set up to ensure that all ideas are reviewed and evaluated promptly by a team of evaluators. There are also automated workflow status checks which can be set up to remind evaluators at pre-set intervals of any ideas that they have not yet reviewed. The present invention also makes it possible for employees or other idea submitters to view the disposition of their own ideas, as well as add comments to others' ideas—using peer review process, helps to shape raw ideas into more complete, compelling solutions.

The system of the present invention works based on pre-defined work-flow and security process utilizing e-mail service to notify the submitter and reviewers about any action taken against the idea. The process of the system is composed of three stages.

The first is a gathering stage. Any employee or other authorized submitter has a chance to benefit the company by submitting innovations using the system directly to any department with no restrictions. The submitter also has the ability to attach any type of documents that support his idea.

In a second or processing stage, every department is defined as an Idea Management Committee (IMC). IMC reviewers or representatives are responsible to review, filter and act on the idea. There are number of services enabled to this level of users such as IMC Voting, Restrictive voting, Transferring ideas and more.

Finally, the third stage to the implementation stage. In this stage, only approved ideas chosen are going to be implemented and monitored by the system implementation process.

The present invention is designed to help entities to focus their employees on specific business issues. This tends to result in a larger quantity of very high quality ideas. IMS focuses employees' creativity around organizational goals and objectives. When employees are asked to generate ideas or suggestions around a specific business problem or objective, the quantity and quality of ideas tends to increase significantly.

By allowing all employees, regardless of their rank to speak their voice to the highest level of the organization if needed, organizational hierarchy is eliminated and individual employees are empowered to deliver their ideas and opinion to anyone without the organization. This feature is of great benefit to many governmental organizations, and organizations where hierarchy may be a problem.

The present invention also encourages employees to capture and record their ideas. In most types of businesses, employees rarely record their ideas. The present invention helps to solve this problem. Employees can quickly jot down an idea, and then return to the system later to add details to their new creation. In addition, the present invention helps employees to share ideas, comment on, add to and further improve each other's ideas, and acquire knowledge by viewing others' ideas.

By placing ideas in a shared repository, the present invention promotes greater transparency in creative research efforts. Employees can see the outcome of ideas they have submitted, which increases their enthusiasm for and participation in idea campaigns. In addition, it is made easier to measure how much each implemented idea has contributed to the firm's bottom line. This makes it easier, in turn, to reward employees who have contributed valuable ideas.

The present invention helps organizations to develop and share best practices. For organizations that have multiple offices or locations, the idea management system of the present invention enables users to quickly and cost-effectively share ideas and best practices that have been used successfully at one location with other locations. This allows them to multiply the bottom-line benefit of a single cost-saving idea many times over.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

What is claimed is:

1. A computer-implemented method of obtaining and managing information regarding ideas for an entity comprising steps of:
receiving a computer information from a submitter in formation concerning an idea, the information including an identification of the submitter, a categorization, title and description of the idea, a description of benefits from the idea, and identification of a submitter selected review organization in the entity which is to be responsible for assessing and taking action on the idea;
storing the received information from the submitter concerning the idea in a memory;
electronically transferring the stored information concerning the idea to members of the review organization for assessing the idea;
electronically transferring the stored information concerning the idea to persons designated to vote on accepting the submitted idea;
receiving electronic votes on the submitted idea from the persons designated to vote;
electronically transferring the stored information to evaluators designated by the entity to evaluate the feasibility of the idea;
receiving electronic indications of the feasibility evaluations of the idea from the evaluators; and
electronically notifying the submitter of the electronic votes and feasibility evaluations of the idea.

2. The method of claim 1, further including the step of:
making the stored information regarding the idea accessible to others in the entity in addition to the submitter, members of the review organization and evaluators on request by such others.

3. The method of claim 2, further including the step of:
receiving and storing additional information from the submitter, members of the review organization, evaluators and such others before and during review and evaluation.

4. The method of claim 1, further including the step of:
receiving and storing additional information from the submitter, members of the review organization, evaluators before and during review and evaluation.

5. The method of claim 1, further including the step of receiving a status assignment from a member of the review organization indicating the present status of review of the idea.

6. The method of claim 5, further including the step of forming a record in the stored information of the status of review of the submitted idea.

7. The method of claim 6, further including the step of making the record of the status of review of the submitted idea available on request.

8. The method of claim 1, further including the step of forming output records of the stored information on request.

9. A data processing system for obtaining and managing information regarding ideas for an entity, the data processing system comprising:
a processor for performing the steps of:
receiving a computer information from a submitter in formation concerning an idea, the information including an identification of the submitter, a categorization, title and description of the idea, a description of benefits from the idea, and identification of a submitter selected review organization in the entity which is to be responsible for assessing and taking action on the idea;
storing the received information from the submitter concerning the idea in a memory;
electronically transferring the stored information concerning the idea to members of the review organization for assessing the idea;
electronically transferring the stored information concerning the idea to persons designated to vote on accepting the submitted idea;
receiving electronic votes on the submitted idea from the persons designated to vote;
electronically transferring the stored information to evaluators designated by the entity to evaluate the feasibility of the idea;
receiving electronic indications of the feasibility evaluations of the idea from the evaluators; and
electronically notifying the submitter of the electronic votes and feasibility evaluations of the idea.
a data output display for providing displays of the stored information from the processor.

10. The data processing system of claim 9, wherein the processor performs the step of:
making the stored information regarding the idea accessible to others in the entity in addition to the submitter, members of the review organization and evaluators, on request by such others.

11. The data processing system of claim 10, wherein the processor performs the step of:
receiving and storing additional information from the submitter, members of the review organization, evaluators and such others before and during review and evaluation.

12. The data processing system of claim 9, wherein the processor performs the step of:
receiving and storing additional information from the submitter, members of the review organization, evaluators before and during review and evaluation.

13. The data processing system of claim 9, wherein the processor performs the step of:
receiving a status assignment from a member of the review organization indicating the present status of review of the idea.

14. The data processing system of claim 13, wherein the processor performs the step of:
forming a record in the stored information of the status of review of the submitted idea

15. The data processing system of claim 14, wherein the processor performs the step of:
making the record of the status of review of the submitted idea available on request.

16. A computer program product stored in signal bearing media for causing a data processor to obtain and manage information regarding ideas for an entity, the computer program product containing instructions stored in machine-readable code and causing the processor to perform the following steps:
receiving a computer information from a submitter in formation concerning an idea, the information including an identification of the submitter, a categorization, title and description of the idea, a description of benefits from the idea, and identification of a user submitted review organization in the entity which is to be responsible for assessing and taking action on the idea;
storing the received information from the submitter concerning the idea in a memory;
electronically transferring the stored information concerning the idea to members of the review organization for assessing the idea;
electronically transferring the stored information concerning the idea to persons designated to vote on accepting the submitted idea;
receiving electronic votes on the submitted idea from the persons designated to vote;
electronically transferring the stored information to evaluators designated by the entity to evaluate the feasibility of the idea;
receiving electronic indications of the feasibility evaluations of the idea from the evaluators; and
electronically notifying the submitter of the electronic votes and feasibility evaluations of the idea.

17. The computer program product of claim 16, further including the product containing in the instructions stored in machine-readable code instructions for causing the processor to perform the step of:
making the stored information regarding the idea accessible to others in the entity in addition to the submitter, members of the review organization and evaluators, on request by such others.

18. The computer program product of claim 17, further including the product containing in the instructions stored in machine-readable code instructions for causing the processor to perform the step of:
receiving and storing additional information from the submitter, members of the review organization, evaluators and such others before and during review and evaluation.

19. The computer program product of claim 17, further including the product containing in the instructions stored in machine-readable code instructions for causing the processor to perform the step of:
receiving and storing additional information from the submitter, members of the review organization, evaluators before and during review and evaluation.

20. The computer program product of claim 17, further including the product containing in the instructions stored in machine-readable code instructions for causing the processor to perform the step of:
receiving a status assignment from a member of the review organization indicating the present status of review of the idea.

21. The computer program product of claim 20, further including the product containing in the instructions stored in machine-readable code instructions for causing the processor to perform the step of:
forming a record in the stored information of the status of review of the submitted idea

22. The computer program product of claim 21, further including the product containing in the instructions stored in machine-readable code instructions for causing the processor to perform the step of:
making the record of the status of review of the submitted idea available on request
